(19) United States
(12) Patent Application Publication
(10) Pub. No.: US 2009/0079098 A1
(43) Pub. Date: Mar. 26, 2009

(54) SYSTEM AND METHOD OF A HEAT PUMP COMBINED WITH A HUMIDIFIER

(76) Inventor: Avi Ezra, Holon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/858,163

(22) Filed: Sep. 20, 2007

(51) Int. Cl. F24F 3/14; F25D 21/14; B01F 3/04

(52) U.S. Cl. 261/128; 62/285; 261/78.2; 261/92; 261/115

(57) ABSTRACT

A system and method for increasing the functionality of a heat pump by collecting condensed water from the cold element of the heat pump and applying the condensed water to humidify the atmosphere of an enclosure being heated or cooled or applying the water to cool a hot element of the heat pump.

### FIELD AND BACKGROUND OF THE INVENTION

The present invention is a method and system to humidify air in an enclosure heated by a heat pump.

Heat pumps are a popular means to heat and cool rooms and buildings. Under many operating conditions, heat pumps are more efficient than conventional heating systems. Many common heat pumps are small units heating and cooling a single room or few rooms. These small units require minimal installation and allow efficient heating and cooling of small spaces. Also by using multiple small units, a large building can be heating and cooled with minimal installation cost and maximum flexibility of operation (by heating or cooling only selected areas of the building); thus saving money and energy as compared to installing a centralized climate control (heating/cooling) system.

Hot air has a much higher moisture capacity than cold air. Therefore, heated air tends to be dry and this dryness causes inconvenience, discomfort and even damage to sensitive materials, equipment or health of sensitive individuals. Therefore, it is common to install a humidifier in centralized heating systems. Humidifiers are well known in the prior art as described for example by Helt et al. in US published patent application 2006/00868 A1 and by Bailey et al. in U.S. Pat. No. 6,347,527. Generally a humidifier requires a source of water. Connecting a centralized climate control system to a water source is seldom a problem because central climate control systems are usually installed in a utility area where water is available and because under any conditions significant installation is required and the extra installation required to connect the system to a water source is not a significant additional expense.

In the case of small heat pumps, supplying water for humidification is less simple. Firstly small heat pumps are often installed in bedrooms or offices that do not have plumbing. Secondly, installation of small heat pumps is usually kept to a minimum, and therefore the added expense of connecting the heat pump to a water supply could be a significant drawback.

Another problem with external water sources is that the water often contains significant quantities of contaminants, such as calcium and salt, which can precipitate out or encourage corrosion or otherwise damage the heat pump or humidifier.

Thus, there is a recognized need for a system that humidifies air from a small heat pump without requiring an external water source. The present invention fulfills this need.

### SUMMARY OF THE INVENTION

The present invention is a method and system for increasing the functionality of a heat pump by collecting condensed water from the cold element of the heat pump and applying the condensed water to humidify the atmosphere of an enclosure being heated or cooled or applying the water to cool a hot element of the heat pump.

According to the present invention there is provided a system for using a heat pump to humidify an enclosure. The system includes a reservoir for collecting condensed water from a cold element of the heat pump and a means to disperse the condensed water into an atmosphere of the enclosure.

According to the present invention there is also provided a system for increasing the functionality of a heat pump. The heat pump has a hot element and a cold element. The system includes a reservoir for collecting condensed water from the cold element, and a means to transport the condensed water from the cold element to the hot element.

According to the present invention there is also provided a method for increasing the functionality of a heat pump. The method includes the steps of collecting condensed water from a cold element of the heat pump, and applying the condensed water.

According to the present invention there is provided a system for using a heat pump to humidify an enclosure. Typical examples of enclosures include a room being heated or a room being cooled or a vehicle being heated or cooled. The system includes a reservoir for collecting condensed water from a cold element of the heat pump. Common examples cold elements include an indoor coil of a heat pump being used to cool an enclosure or an outdoor coil of a heat pump being used to heat an enclosure. The system also includes a means to disperse the condensed water into the atmosphere of the enclosure.

According to further features in preferred embodiments of the invention described below, the system further includes a means to transport the condensed water to a hot element of the heat pump. Common examples of hot elements of the heat pump include a hot indoor coil of a heat pump being used to heat an enclosure, a hot indoor air stream of a heat pump being used to heat an enclosure, and a hot outdoor coil of a heat pump being used to cool an enclosure.

According to still further features in the described preferred embodiments, the means to transport condensed water includes a tube or a gravity driven channel or a pump.

According to still further features in the described preferred embodiments, means to disperse condensed water into the atmosphere includes an atomizer, a sponge wheel humidifier or a sprayer.

According to the present invention there is also provided a system for increasing the functionality of a heat pump. The heat pump has a hot element and a cold element. The system includes a reservoir for collecting condensed water from the cold element (collecting condensed water from the cold element commonly entails catching water dripping off the cold element in a reservoir), and a means to transport the condensed water from the cold element to the hot element. Transporting the water to the hot element does not mean only that the water is brought in direct contact with the hot element but also includes transporting the condensed water to the atmosphere in the vicinity of the hot element).

According to further features in preferred embodiments of the invention described below, the condensed water serves to humidify an atmosphere or to cool the hot element.

According to still further features in the described preferred embodiments, the means to transport water includes a tube or a gravity driven channel or a pump.

According to still further features in the described preferred embodiments, the system further includes a means to disperse the condensed water into an indoor atmosphere of an enclosure that is being heated.

According to still further features in the described preferred embodiments, the means to disperse water into an atmosphere includes an atomizer or a sponge wheel humidifier or a sprayer.

According to the present invention there is also provided a method for increasing the functionality of a heat pump. The method includes the steps of collecting condensed water from a cold element of the heat pump and applying the condensed water to a location where the water will improve efficiency of the heating pump or where the water will improve the conditions of the enclosure being heated or cooled.

According to further features in preferred embodiments of the invention described below, the step of applying the condensed water includes cooling a hot element of the heat pump or dispersing the condensed water into the atmosphere of an enclosure being heated or dispersing the condensed water into the atmosphere of an enclosure being cooled.

According to further features in preferred embodiments of the invention described below, the method further includes the step of generating additional condensation when the step of collecting condensed water does not result in enough water for the step of applying (particularly when the reservoir of condensed water does not contain enough water to apply to the desired goal).

According to farther features in preferred embodiments of the invention described below, generating additional water includes increasing a pressure in a compressor or venting outdoor air into an enclosure being heated or cooled.

### BRIEF DESCRIPTION OF THE DRAWINGS

The invention is herein described, by way of example only, with reference to the accompanying drawings, where:

FIG. 1 is a schematic illustration of a first embodiment of a split heat pump combined with a humidifier in accordance with the present invention.

FIG. 2 is a schematic illustration of a second embodiment of a split heat pump combined with a humidifier in accordance with the present invention.

FIG. 3 is a flow chart illustrating a method of using condensed water to enhance the functioning of a heat pump during a cooling cycle according to the current invention.

FIG. 4 is a flow chart illustrating a method of using condensed water to enhance the functioning of a heat pump during a heating cycle according to the current invention.

It will be appreciated that for simplicity and clarity of illustration, elements shown in the figures have not necessarily been drawn to scale. For example, the dimensions of some of the elements may be exaggerated relative to other elements for clarity.

### DESCRIPTION OF THE PREFERRED EMBODIMENTS

The principles and operation of a system and method for improving the operation of a heat pump using condensed water according to the present invention may be better understood with reference to the drawings and the accompanying description. It will be understood by those of ordinary skill in the art that the invention may be practiced without these specific details. In other instances, well-known devices, methods, procedures, and/or components have not been described in detail so as not to obscure the invention.

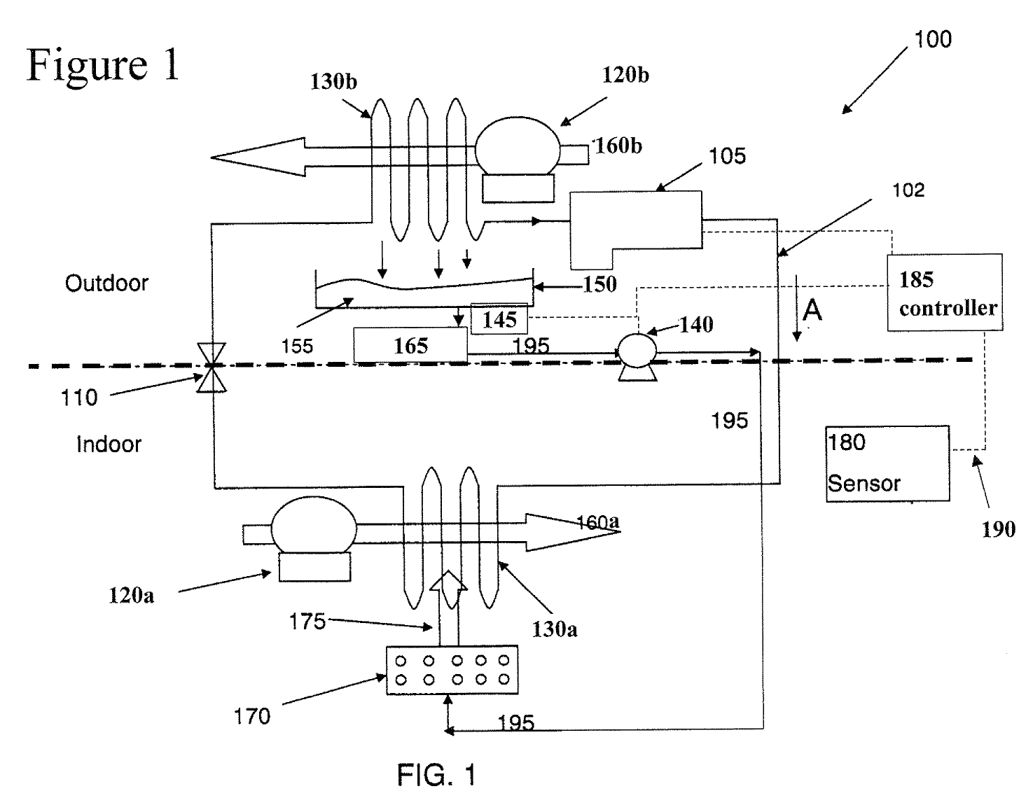

Reference is made to FIG. 1, which schematically illustrates a split air-conditioning system combined with a humidifier in accordance with a first embodiment 100 of the present invention.

First embodiment 100 includes the following components: a coolant piping system 102 circulating therein a cooling agent having physical properties suitable for an air conditioning system, as known in the art. Particularly in embodiment 100, the cooling agent is Freon. Coolant piping system 102 includes a compressor 105, an expansion valve 110, an indoor blower 120a, an outdoor blower 120b, indoor coils 130a and outdoor coils 130b.

Embodiment 100 operates either in a cooling cycle or in a heating cycle. When operating in the heating cycle, the cooling agent in coolant piping system 102 flows therein in a direction as indicated with arrow A. In the heating cycle, compressor 105 compresses the cooling agent, which is in a substantially gaseous state, in coolant piping system 102. Compressing the cooling agent causes the pressure of the cooling agent to rise, thereby increasing the temperature of the cooling agent. During the heating cycle, the pressurized, hot cooling agent runs through indoor coils 130a. Thus, when the heat pump is running in heating cycle, indoor coils 130a are the hot coils. While the hot cooling agent runs through indoor coils 130a, indoor blower 120a blows an indoor air stream 160a over indoor coils 130a, thereby causing the cooling agent's heat energy to dissipate to indoor air stream 160a by convection, as known in the art. As heat dissipates from the cooling agent to indoor air stream 160a, the cooling agent is cooled and consequently the cooling agent substantially condensates, changing from gaseous state to a liquid state. The cooling agent then runs through expansion valve 110, thereby reducing the pressure of the cooling agent. As a result of the lower pressure after passing through expansion valve 110 the cooling agent undergoes a transition from the liquid state to a substantially gaseous state expanding and reducing in temperature. The very cold, gaseous cooling agent runs then through outdoor coils 130b. Thus, in the heating cycle, outdoor coils 130b are the cold coils. Outdoor blower 120b blows an outdoor air stream 160b of cool (but nevertheless warmer then the very cold cooling agent) air around coils 130b, the very cold, substantially gaseous cooling agent absorbs at least some heat from outdoor air stream 160b. Consequently, at least some water vapor contained in outdoor air stream 160b condensates into a liquid state to condensed water 155. The cooling agent reenters then compressor 105 and the events characterizing the heating cycle recur, as known in the art. (It will be understood to one familiar with the art that in contrast to the heating cycle of FIG. 1 as described above, in the cooling cycle, indoor coils 130a are the cold coils and outdoor coils 130b are the hot coils.)

In embodiment 100 a means is provided to transfer condensed water 155 from outdoors to indoors. Furthermore, a means is provided for atomizing, i.e. generating droplets out of condensed water 155 and spraying the atomized condensed water 155 into the indoor atmosphere, thereby increasing the indoor humidity, as will be outlined in detail below.

In embodiment 100, condensed water 155 is collected in an outdoor reservoir 150. From outdoor reservoir 150, condensed water 155 is pumped by a pump 140 over a water piping system 195 into an atomizer 170. In embodiment 100, atomizer 170 has a perforated structure and is a portion of water piping system 195. Pump 140 increases the pressure of condensed water 155 such that condensed water 155 may become atomized and is dissipated into the air while passing through atomizer 170. Thus, condensed water 155 is formed into droplets 175. In embodiment 100 the location of atomizer 170 is such that droplets 175 are blown into indoor air stream 160a at the outlet of indoor blower 120a. As a consequence, humidity is increased in indoor air stream 160a. Furthermore, droplets 175 are blown towards coils 130a. Therefore, at least some of droplets 175 are vaporized, thereby facilitating the dissipation of the humidity within indoor air stream 160a.

According to embodiment 100 reservoir 150 is supplied with a pressure sensor 145, which reports to a controller 185. When sensor 145 reports to controller 185 that reservoir 150 is low on water then controller 185 commands compressor 105 to increase the pressure of the cooling agent thus ultimately reducing the temperature of coil 130b and increasing condensation and increasing flow of condensed water 155 into reservoir 150. Alternatively, when the water level in reservoir 150 becomes low, controller 185 vents cool outside air from outdoors to indoors to lower the indoor temperature thereby increasing the workload of the heat pump and thus increasing condensation. Alternatively, a hand filled emergency reservoir may be provided or the humidifying system may be shut down or other methods may be used to balance the water supply and demand as will be understood to those familiar with the art.

A charcoal filter 165 is supplied on water piping 195 before pump 140 in order to assure that odor which may build up in reservoir 150 or elsewhere does not get spread into the indoor air. It will be understood that condensed water 155 will usually be clean. Nevertheless, in certain environments (where the heat pump is located near a source of dust or grit) dirt may build up on coils 130b and get into condensed water 155. Alternatively, a filter may be supplied before the atomizer 170 as is known to those skilled in the art.

It will be understood to one familiar with the art that the configuration of the humidifying apparatus may vary in different embodiments of the invention. For example, water may be fed directly from pump 140 to another pump or reservoir to allow more flexible control of humidification or there may be multiple atomizers.

According to embodiment 100, a humidity sensor 180 is installed indoors. Humidity sensor 180 sends signals representing indoor humidity measurements, via a control circuit 190, to a controller 185. According to the output of humidity sensor 180, controller 185 sends commands to operate pump 140. For example, when controller 185 receives a signal from humidity sensor 180 indicating that the indoor humidity level is below a certain predetermined threshold, then controller 185 provides pump 140 with a command to increase the operational speed of pump 140. In turn, the flow rate of condensed water 155 from reservoir 150 to atomizer 170 is increased, thereby increasing the generation of droplets 175. Conversely, when controller 185 receives a signal from humidity sensor 180 that the indoor humidity level is above a second predetermined threshold, e.g., 60%, then controller 185 commands pump 140 to decrease the operational speed of pump 140, thereby decreasing the flow rate of condensed water 155 from reservoir 150 towards atomizer 170. It may be noted that in the present description, “humidity” refers to relative humidity, as known in the art.

According to embodiment 100, pump 140, reservoir 150, atomizer 170, humidity sensor 180, controller 185, control circuit 190, and piping system 195 are provided as a separate kit and may therefore be installed as such to an existing split air conditioning system.

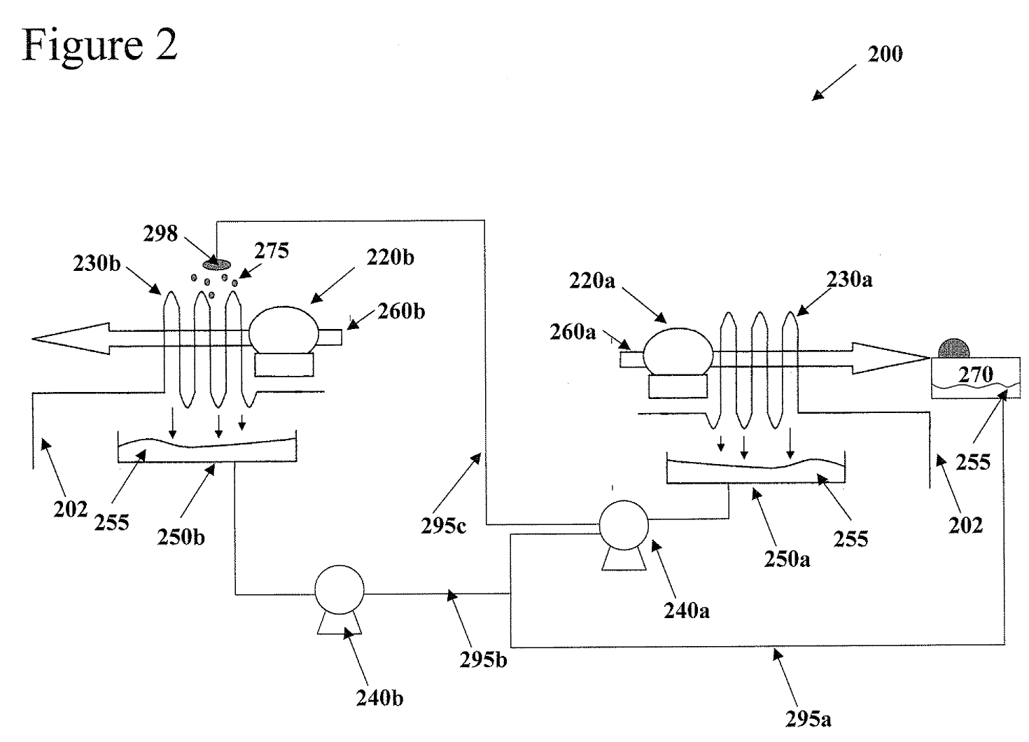

FIG. 2 is a schematic illustration of a second embodiment 200 of the present invention. In embodiment 200 many details of the heat pump are not illustrated (as they are not the subject of this invention), but their presence and functioning are similar to the heat pump of embodiment 100 and are well understood to one familiar with the art. In FIG. 2 illustrates embodiment 200 including an indoor coil 230a, an indoor reservoir 250a, an indoor blower 220a, and an indoor air stream 260a as well as an outdoor coil 230b, an outdoor reservoir 250b, an outdoor blower 220b, and an outdoor air stream 260b. Coolant piping 102 is only shown partially in FIG. 2 because it is similar to prior art heat pumps and to embodiment 100 and will be understood to those skilled and the art.

During the heating cycle water condenses on the cool outdoor coil 230b. Condensed water 255 is collected in outdoor reservoir 250b and sent via pump 240b through piping 295b and 295a to a sponge wheel (rotating disk) humidifier 270 (as is well known in the art). The heating cycle of embodiment 200 is thus similar to that described above in embodiment 100 except for the use of sponge wheel humidifier 270 in place of atomizer 170. Sensors for humidity and condensed water 255 level are not shown in FIG. 2, but may be added in a manner similar to embodiment 100 as will be understood to one familiar with the art.

During the cooling cycle water condenses on cool indoor coil 230a and condensed water 255 is collected in indoor reservoir 250a. Depending on the temperature differential of indoor coil 230a and indoor ambient air, and dependent on the air flow rate of air stream 260a as well as the initial ambient humidity, it sometimes occurs that a heat pump in its cooling cycle removes significant amounts of water from the indoor air and leaves the indoors uncomfortably dry (causing dry throats and summer colds etc.) therefore in embodiment 200 a pump 240a is provided to pump condensed water 255 from indoor reservoir 250a via tubing 295a to a humidifier 270 during the cooling cycle.

At times when the heat pump of embodiment 200 is running in the cooling cycle and the indoor atmosphere (inside the enclosure being cooled) is not lacking in humidity, pump 240a pumps condensed water 255 into tubing 295c causing condensed water 255 to be transported via tubing 295c to a sprayer 298 which sprays droplets 275 onto the hot coil (which during the cooling cycle is outdoor coil 230b), thereby cooling outdoor coil 230b and increasing the efficiency of the heat pump (as will be understood by those skilled in the art).

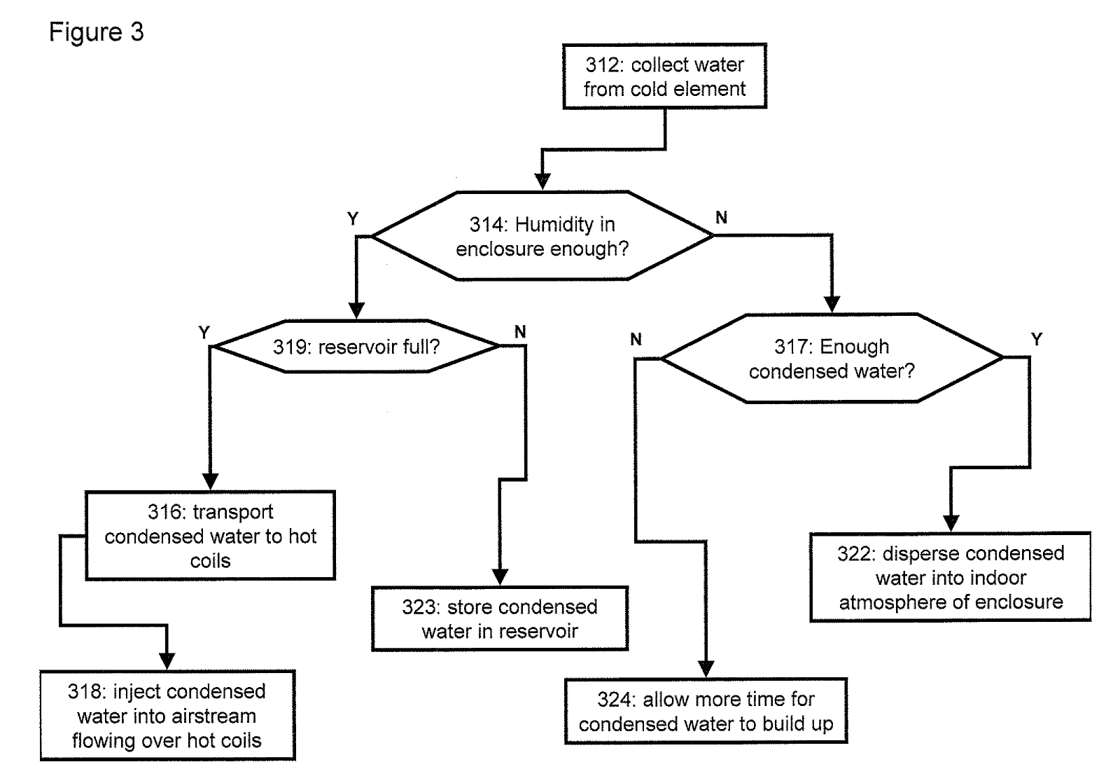

Attention is now directed to FIG. 3, which is a flow chart illustrating a method according to the current invention for using condensed water to enhance the functioning of a heat pump during a cooling cycle.

In a cooling cycle, the method begins by collecting 312 condensed water 255 from a cold element (in the cooling cycle the cold element is the indoor coil e.g. 230a, alternatively for a solid state heat pump a cold element could be a metal plate) to an indoor reservoir 250a. Then a sensor (similar to sensor 180) is used for determining 314 if the humidity of the cooled enclosure is above a minimum threshold (examples of enclosures being cooled include an office or a room of a home or a vehicle [for example a car or a bus]). For example if the humidity in the enclosure is below 20% then the condensed water 255 level of reservoir 250a is tested 317. If there is enough condensed water 255 in indoor reservoir 250a then condensed water 255 is dispersed 322 into the atmosphere of the enclosure. Dispersion 322 of condensed water 255 into the enclosure may be by means of an atomizer similar to atomizer 170 or by a sponge wheel humidifier similar to sponge wheel humidifier 270. If there is not sufficient water in reservoir 250a, then the humidifier 270 is left inactive, giving time for condensed water 255 to build up. Humidifier 270 for a cooling cycle will not be located in the air stream before (upstream of) the indoor element (as in embodiment 100) because then the dispersed condensed water 255 would just be recondensed when the humid air passes over the cold element (coils 230a). If the humidity in the enclosure is determined 314 to be sufficient then the water level in the cold coil reservoir (which in the cooling cycle is the indoor reservoir for example reservoir 250a) is tested 319. If reservoir 250a is full then the cold condensed water 255 is transported 316 to the hot (outdoor) element (for example 230b) and injected 318 into air stream 260b cooling the hot (outdoor) elements (for example coils 230b). Injection 318 may be by a sprayer 298 or an atomizer (similar to atomizer 170 but located in air stream 260b before (upstream of) the outdoor coil [which is the hot coil in the cooling cycle]). As will be understood by one familiar with the art, injecting cold condensed water 255 into the air stream before the hot coils 230b will make the heat pump more efficient by directly cooling air stream 260b and therefore also cooling hot coils 230b. Hot coils 230b are also further cooled due to the vaporization of condensed water 255. If reservoir 250a is tested 319 and found to be not full, then condensed water 255 is stored 323 in the reservoir 250a.

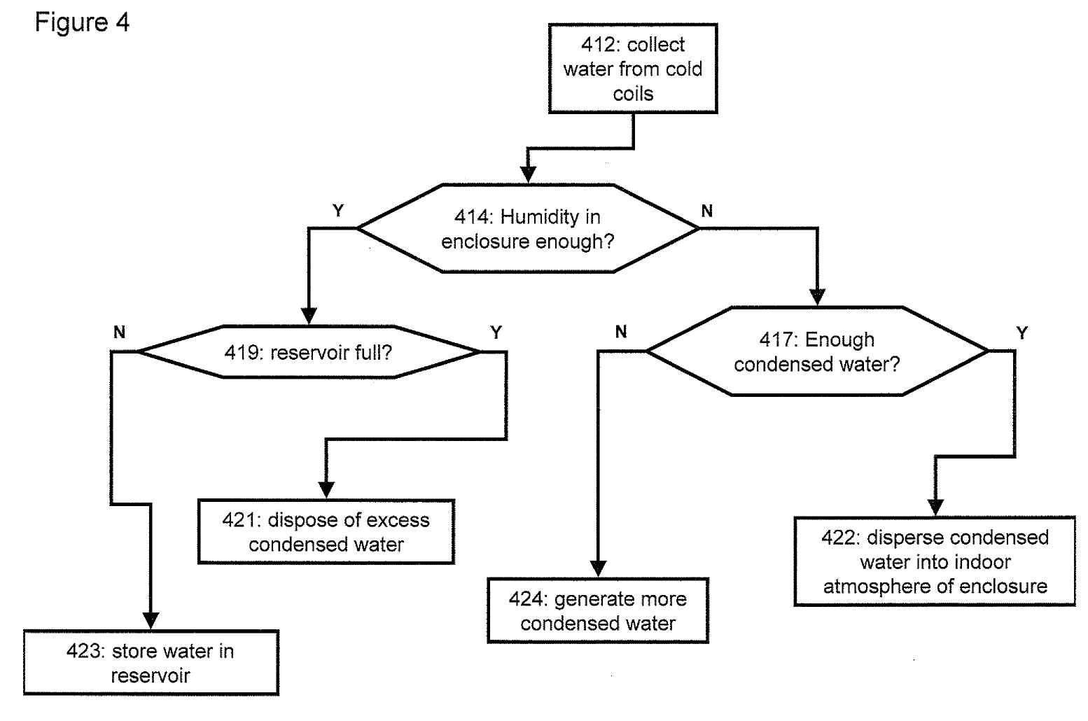

Attention is now directed to FIG. 4, which is a flow chart illustrating a method according to the current invention for using condensed water to enhance the functioning of a heat pump during a heating cycle. The method begins by collecting 412 condensed water 155 from a cold element (in the heating cycle the cold element is the outdoor coil e.g. 130b alternatively for a solid state heat pump a cold element could be a metal plate). Then a sensor (for example sensor 180) is used for determining 414 if the humidity of the heated enclosure is above a minimum threshold (examples of enclosures being heated include an office or a room of a home or a vehicle [for example a car or a bus]). If the humidity in the enclosure is determined 414 to be below the threshold (for example below 30%) then the water level in the cold coil reservoir (in the heating cycle, the cold reservoir is the outdoor reservoir for example 150) is tested 417. If reservoir 150 has sufficient condensed water 155 then condensed water 155 is transported 416 to the hot element (in the heating cycle the hot element is the indoor element for example coils 130a) and dispersed 422 into the (indoor) atmosphere of the enclosure. Dispersion 422 of condensed water 155 into the enclosure may be by means of an atomizer 170 or by a sponge wheel humidifier 270. Preferentially an atomizer similar to atomizer 170 is located in the air stream after (downstream) of the indoor element (e.g. coils 230a) and thus the atomizer can be used both during the cooling and heating cycles. Alternatively for the heating cycle (as in embodiment 100) atomizer 170 may be located before (upstream) of coils 130a. If the reservoir 150 is tested 417 and found to contain insufficient condensed water 155, then more condensed water 155 is generated 424. Condensed water 155 can be generated by various means that will be understood to one familiar with the art, for example by increasing the pressure on the compressor (decreasing the temperature of the cold coil and increasing condensation) or by venting cold (outside) air into the enclosure causing the heat pump to work more to heat the enclosure and thus increasing condensation.

If the humidity in the enclosure is determined 414 to be sufficient then the level of condensed water 155 in the cold coil reservoir (in the heating cycle the cold coil is the outdoor coil (e.g. coil 230b) and condensed water 155 is collected in the outdoor reservoir for example reservoir 150) is tested 419. If the reservoir is fill then the excess condensed water 155 is disposed of 421. If reservoir 150 is not fill than condensed water 155 is stored 423 in reservoir 150.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention and will appreciate that many variations, modifications and other applications of the invention may be made.

What is claimed is:

1. A system for using a heat pump to humidify an enclosure comprising:
a) a reservoir for collecting condensed water from a cold element of the heat pump, and
b) a means to disperse said condensed water into an atmosphere of the enclosure.

2. The system of claim 1, further comprising
c) a means to transport said water to a hot element of the heat pump.

3. The system of claim 2, wherein said means to transport includes at least one means selected from the group consisting of a tube, a gravity driven channel and a pump.

4. The system of claim 1, wherein said means to disperse includes at least one means selected from the group consisting of an atomizer, a sponge wheel humidifier and a sprayer.

5. A system for increasing the functionality of a heat pump having a hot element and a cold element comprising:
a) a reservoir for collecting condensed water from the cold element, and
b) a means to transport said condensed water from the cold element to the hot element.

6. The system of claim 5, wherein said condensed water serves at least one function selected from the group consisting of humidifying an atmosphere and cooling a hot air stream.

7. The system of claim 5, wherein said means to transport includes at least one means selected from the group consisting of a tube, a gravity driven channel and a pump.

8. The system of claim 5, further comprising
c) a means to disperse said condensed water into an indoor atmosphere.

9. The system of claim 4, wherein said means to disperse includes at least one means selected from the group consisting of an atomizer, a sponge wheel humidifier and a sprayer.

10. A method for increasing the functionality of a heat pump comprising the steps of:
a) collecting a condensed water from a cold element of the heat pump, and
b) applying said condensed water.

11. The method of claim 10, wherein said step of applying includes at least one application selected from the group consisting of dispersing said condensed water into a hot air stream, dispersing said condensed water into a outdoor air stream, dispersing said condensed water into an indoor air stream, dispersing said condensed water into the atmosphere of an enclosure being heated, and dispersing said condensed water into the atmosphere of an enclosure being cooled.

12. The method of claim 10, further comprising the step of:
c) generating additional condensation when said step of collecting does not result in enough water for said step of applying.

13. The method of claim 12, wherein said step of generating includes at least one action selected from the group consisting of increasing a pressure in a compressor and venting outdoor air into an enclosure.
